(19) United States
(12) Patent Application Publication
(10) Pub. No.: US 2010/0150313 A1
(43) Pub. Date: Jun. 17, 2010

(54) COOLING DEVICE FOR A ROTATABLE ANODE

(75) Inventor: Jules Hendrix, Hamburg (DE)

Correspondence Address: KELLY LOWRY & KELLEY, LLP, 6320 CANOGA AVENUE, SUITE 1650, WOODLAND HILLS, CA, 91367, US

(73) Assignee: MARRESEARCH GMBH, Norderstedt (DE)

(21) Appl. No.: 12/063,620

(22) PCT Filed: Aug. 18, 2006
(86) PCT No.: PCT/EP2006/008161

§ 371 Date: Mar. 1, 2010

(30) Foreign Application Priority Data
Aug. 19, 2005 (DE) 20 2005 013 232.2

(51) Int. Cl. H01J 35/10; H01J 35/00

(52) U.S. Cl. 378/130; 378/132; 378/144

(57) ABSTRACT

The invention relates to a cooling device (100) for a rotatable anode (10) which is used for producing X-rays in an X-ray tube comprising a focal path (11), on which an electron stream is projected, and supporting elements (15). In order to efficiently cool the rotatable anode, a liquid (13) is located between the focal path (11) and the supporting elements (15), said supporting elements (15) simultaneously form condensation surfaces (16) and a vaporisation surface is formed on the focal path (11), the liquid is evaporated on the evaporation surface (19) and appears on the condensation surfaces (16) in the form of a vapour (18), wherein it is condensed for returning to the focal path (11) in the form of a condensate (22) by the action of centrifugal forces applied on the rotatable anode (10).

### TECHNICAL FIELD

This invention relates to a cooling device for a rotatable anode for producing X-radiation in a X-ray tube, whereby the rotatable anode has a focal path onto which an electron flow hits and bearing parts.

### Prior Art

Cooling devices for X-ray rotatable anodes are known from the prior art. X-ray rotatable anodes are used for example for research, medical radiology, structure and material research or even in medical diagnostic applications. In case of X-ray rotatable anodes, thermal output is delivered at high vacuum on the focal surface of the anode by the electron bombardment. In order to avoid a fusing of the anode material, the anode has to be cooled. Since the cooling due only to rotation or increase of the rotational speed of the anode is insufficient, in nowadays technology the anode is water-cooled. However, a cooling by water has the disadvantage that a turbulent flow is necessary for the efficient heat transfer. This flow produces a loss due to friction (friction) which also has to be cooled off.

Presentation of the Invention, aim, Solution, Advantages

Thus, the aim of this invention is to make available a cooling device for a rotatable anode which makes possible a more efficient cooling.

This aim is achieved by a cooling device with the characteristics indicated in claim 1.

The basic idea of the invention is to base the cooling of the anode on the so-called heat pipe principle. The fact that there is a liquid between the focal path and the bearing parts which evaporates on the evaporation surface serves for this purpose. The evaporation surface is heated up by the electron bombardment onto the focal surface. This vapour arrives then to the bearing parts on which there is a depression because of the temperature gradient and a condensation takes place. The condensation surface results from the temperature gradient which adjusts between the evaporation surface and the bearing parts which also fulfil the function of a condensation surface. The transport of the condensate back to the focal path is carried out by the centrifugal forces of the rotating anode. In this manner the heat circuit of a heat pipe is closed.

The advantage of the invention is to be seen in that the evaporation heat of the liquid in the concerned temperature range achieves an additional cooling effect compared to the normal cooling by flowing. The heat transfer is much higher than that in case of a flowing liquid. Additionally, the construction of the cooling device which is based on the heat pipe principle is simple and cost saving since only the space between the bearing parts and the focal path is used.

A practicable alternative of the invention provides that the condensate arrives to the evaporation surface which is formed on the focal surface.

It is advantageous that the parts of the bearing are connected gas-tightly with the focal path. This takes into consideration that the rotatable anode is at high-vacuum.

Sliding bearings are considered to be effective condensation surfaces. Thus, the bearing is preferably a sliding bearing.

The fact that there are ribs on the bearing parts also serves this purpose. The ribs additionally serve to the bearing stiffness.

An advantageous configuration of the invention provides that the liquid is water. This takes into consideration that it is known that water has a high heat capacity.

But it is also conceivable that the liquid is alcohol.

In order to guarantee the discharge of the heat flow, claim 8 provides that a cooling flow flows in the bearing parts. For the cooling flow, the matter can also be, for example, of nitrogen or cooling gas. A cooling of a rotatable anode by means of a cooling flow is disclosed, for example, in the patent document DE 36 44 719 C1 and can be used within the scope of this invention.

An advantageous configuration of the invention provides that the ribs are placed on the bearing parts in axial direction.

In order to generate a quicker evaporation, a practicable alternative of the invention provides that the evaporation surface is enlarged by knurls and/or ribs. Due to the fact that the evaporation surface is enlarged by knurling and/or ribs, a rough surface is created which causes a quicker evaporation.

Finally, the invention provides a method for cooling a rotatable anode for which liquid is evaporated on a focal path of the rotatable anode and the evaporated liquid simultaneously arrives to bearing parts which act as condensation surface on which the evaporated liquid will condense, whereby the condensate of the focal path is fed again by the centrifugal force of the rotatable anode. This being, the condensate can arrive to an evaporation surface which is configured on the focal path.

Preferably, the bearing parts are then gas-tightly connected with the focal path, whereby the bearing parts are used as sliding bearing.

According to the method, ribs can be used on the bearing parts.

### SHORT DESCRIPTION OF THE DRAWINGS

Embodiments of the invention are explained below by reference to the drawings.

FIG. 1 shows a schematic top view representation of the cooling device according to this very invention.

FIG. 2 shows a schematic longitudinal section representation of the cooling device according to this invention.

### BEST WAY FOR CARRYING OUT THE INVENTION

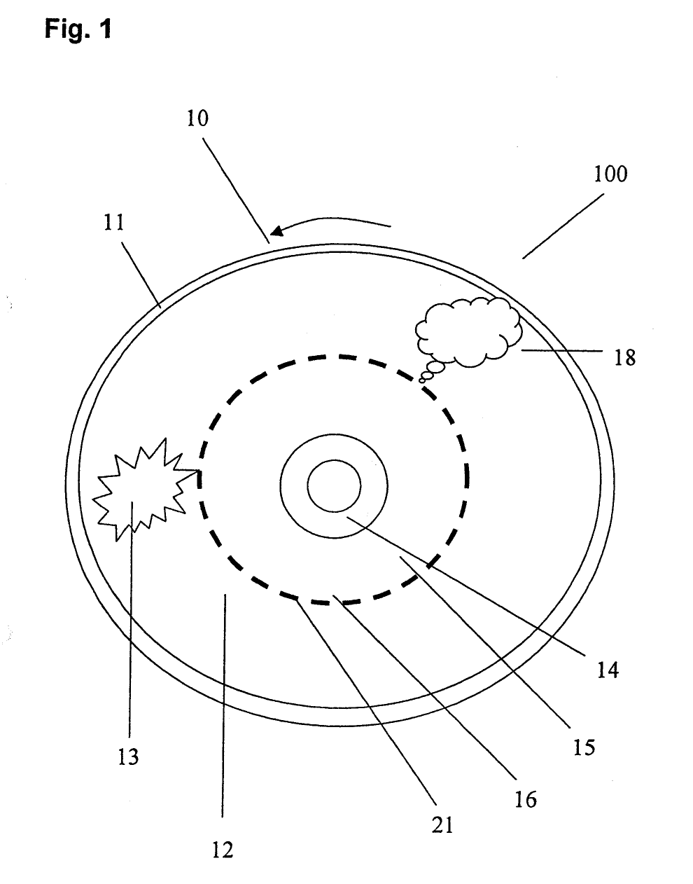

A cooling device according to the invention 100 of a rotatable anode 10 is represented in FIG. 1. The rotatable anode 10 has a focal path 11 onto which the electron flow hits. Between the bearing parts 15 and the focal path 11 there is a hollow space 12 in which there is a liquid 13. The material of the focal path is a metal. Cupper or chrome are appropriate as a metal. For the liquid 13, the matter can be of water. But it is also conceivable that the liquid 13 does exist as alcohol. The bearing parts 15 are situated on the axle 14 of the rotatable anode 10 and constitute simultaneously condensation surfaces 16. Moreover, there is still an evaporation surface 19 on the focal path 11, surface on which the liquid evaporates and arrives as vapour 18 to the condensation surfaces. Ribs 21 are on the bearing parts 15 for an effective condensation.

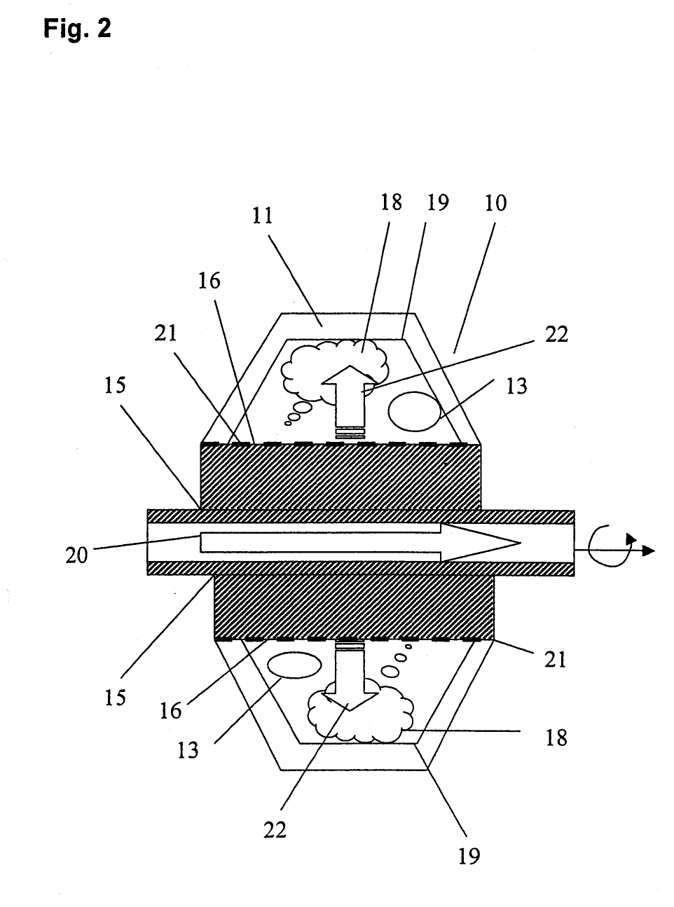

In FIG. 2, once again, the cooling device 100 for a rotatable anode 10 for producing X-ray radiation in a X-ray tube can be seen for which the rotatable anode 10 has a focal path 11 onto which an electron flow hits and which has bearing parts 15. A liquid 13 is situated between the focal path 11 and the bearing parts 15. The bearing parts 15 simultaneously constitute condensation surfaces 16, whereby an evaporation surface 19 on which the liquid 13 evaporates is situated on the focal path 11. The vapour 14 arrives then to the condensation surfaces 16 on which there is a depression due to the temperature gradient and a condensation takes place. The transport of the condensate 22 back to the evaporation surface 19 is carried out by the centrifugal forces of the rotatable anode 10. In this way the heat circuit is closed. The bearing parts 15 are gas-tightly connected with the focal path 11. Ribs 21 are situated on the bearing parts 15, whereby the matter can be, for the bearing parts, of sliding bearings. Because of the high heat capacity of water, it is judicious that the liquid 13 exists as water. But it is also conceivable that the liquid 13 exists as alcohol. Finally, a cooling flow 20 is provided in the bearing parts 15 in order to evacuate the heat flow.

1. A cooling device for a rotary anode for producing X-radiation in a X-ray tube, for which the rotatable anode has a focal path onto which an electron flow hits and bearing parts, characterized in that:
a liquid is disposed between the focal path and the bearing parts, and the bearing parts simultaneously constitute condensation surfaces; and
an evaporation surface is configured on the focal path, whereby the liquid evaporates on the evaporation surface and arrives as vapour to the condensation surfaces in order to condense there and to go back as condensate to the focal path due to the centrifugal forces of the rotatable anode.

2. The cooling device according to claim 1, characterized in that the condensate arrives to the evaporation surface which is formed on the focal path.

3. The cooling device according to claim 1, characterized in that the bearing parts are gas-tightly connected with the focal path.

4. The cooling device according to claim 3, characterized in that the bearing parts comprise sliding bearings.

5. The cooling device according to claim 1, characterized in that ribs are situated on the bearing parts.

6. The cooling device according to claim 1, characterized in that the liquid comprises water.

7. The cooling device according to claim 1, characterized in that the liquid comprises alcohol.

8. The cooling device according to claim 1, characterized in that a cooling flow flows in the bearing parts.

9. The cooling device according to claim 5, characterized in that the ribs are placed on the bearing parts in an axial direction.

10. The cooling device according to claim 1, characterized in that the evaporation surface is enlarged by knurls or ribs.

11. A method for cooling a rotatable anode, characterized in that:
liquid evaporates on a focal path of the rotatable anode and arrives as vapour to bearing parts simultaneously acting as condensation surfaces on which the vapour condenses, whereby the condensate is immediately fed back to the focal path by the centrifugal force of the rotatable anode.

12. The method according to claim 11, characterized in that the condensate arrives to an evaporation surface which is configured on the focal path.

13. The method according to claim 11, characterized in that the bearing parts are gas-tightly connected with the focal path.

14. The method according to clam 13, characterized in that sliding bearings are used as bearing parts.

15. The method according to claim 11, characterized in that ribs are placed on the bearing parts.
